(19) United States
(12) Patent Application Publication
(10) Pub. No.: US 2006/0291136 A1
(43) Pub. Date: Dec. 28, 2006

(54) Lighting equipment

(75) Inventor: Kiyoshi Okishima, Kanagawa (JP)

Correspondence Address: Patrick G. Burns;GREER, BURNS & CRAIN, LTD., Suite 2500, 300 South Wacker Drive, Chicago, IL, 60606, US

(73) Assignee: SANYO TECNICA CO., LTD.

(21) Appl. No.: 11/370,467

(22) Filed: Mar. 8, 2006

(30) Foreign Application Priority Data
Jun. 24, 2005 (JP) 2005-184345

(51) Int. Cl. H01G 5/00

(52) U.S. Cl. 361/289

(57) ABSTRACT

In the present invention a lighting equipment driving means which make it possible to drive a light emitting means to emit light for a long time with high brightness even when a moving speed of a bicycle is at so low level of speed that a normal human being walks, is provided and in the light emitting means, the driving terminal 4, 4′ of the small sized direct current motor 1 and the input terminals 7, 7′ provided on a substrate plate 6 of the light emitting means 5 with the LED 15 are connected to each other directly via a pair of conduction wires 8, 8′, without interposing any one of a rectifier circuit and an electric energy storage circuit, wherein a rotor axis 2 of the small sized direct current motor 1 is rotated at high rotational speed to generate the electricity whereby said light generating means 5 emits light continuously and uniformly in high luminance condition.

### BACKGROUND OF THE INVENTION

1. Field of the Invention

The present invention relates to lighting equipment and especially relates to a lighting equipment used for a bicycle.

2. Related Arts

In the past, an electric bulb utilizing a filament has been used for a front light of a bicycle, however in the recent years, practical usage of a semiconductor light emitting devise, for example, a LED or the like is improving since such semiconductor light emitting devise can make a power consumption thereof less than about one third comparing with that of the conventional electric bulb with keeping its brightness substantially equal to each other.

Note that the past lighting equipment to be used for a bicycle is configured so that a part of a generator for a bicycle is contacted to a tire portion of a wheel of the bicycle and electric power is generated by the generator utilizing a rotational movement of the tire.

Such kind of lighting equipment for a bicycle is shown in, for example, Japanese Unexamined Utility Model Publication No. 1-158390 (reference No. 1) or Japanese Unexamined Utility Model Publication No. 7-26292 (reference No. 2).

Both of these references disclose a lighting equipment in which the electric bulb with a filament emits light utilizing an alternating voltage generated from such alternating current generator (A.C. generator) via a rectifier circuit with a smoothing capacitor if necessary and a charging capacitor or a constant power source comprising batteries.

On the other hand, for example, Japanese Unexamined Patent Publication No. 2000-62523 (reference No. 3) or the like shows a separate bicycle lighting equipment which is configured so that the electric bulb emits with an electric energy obtained by rotating a hub-dynamo which is provided at a hub portion of a wheel of a bicycle utilizing a rotation of the wheel.

However, this kind of lighting equipment has an inevitable constructional requirement in which it must necessarily use a rectifier circuit and a charging capacitor and thus the circuit construction thereof becomes complicated resulting in its manufacturing costs being increased.

Further, in such conventional lighting equipment, the generator and the illuminating bulb are connected with each other via a rectifier circuit and/or a smoothing circuit so as to supply the electric energy generated from the generator to the illuminating bulb and thus the electric energy as supplied to the illuminating bulb is necessarily depended upon a rotational movement of a wheel of the bicycle.

Accordingly, in a case when the rotational number of the wheel is small, for example, an user of the bicycle walks with pushing the bicycle, the electric bulb cannot emit light with high brightness causing to give the user of the bicycle a dangerous condition in night time.

In order to improve these kind of problems, as shown in the above-mentioned reference No. 2, it is proposed that a separate constant power source including at least one battery is provided and when the bicycle moves with a low speed in nigh time, such electric bulb is illuminated by supplying necessary electric power from the battery.

However, such kind of method utilizing the batteries usually has a deficiency in that the battery must be exchanged and it must be charged, causing the use-ability thereof to be inconvenient.

And further, it is understood that there exists further demerit thereof since the electric bulb necessarily consumes consumption electricity of around 3 to 6 W (watts) and additionally the electric bulb is an expendable good so that it must be exchanged, frequently.

On the other hand, in order to improve the problem in which a lack of luminance is occurred when the bicycle moves with a low speed, it is well-known that the above-mentioned system as shown in the reference No. 3 can be used.

Note that a control means for controlling to turn on an illuminating bulb for a bicycle as disclosed in the reference No. 3, is a one in which after an electric power output from a generator is rectified first and is converted into a certain level of a direct current voltage utilizing a constant voltage circuit, this constant voltage is supplied to the illuminating bulb to illuminate it.

However, in this reference No. 3, a capacitor is especially provided and this capacitor is so configured to be charged when the bicycle moves with high speed, while when the bicycle moves with low speed, electric charge charged in the capacitor is discharged so as to illuminate the electric bulb.

However, the controlling means as described above, has a separate problem in which since an electric power consumption of the electric bulb is relatively large, it is difficult for the electric bulb to be illuminated for a long time, as well as it has another problem in that since the capacitor has not yet charged just after the bicycle starts to move, the light emitting means cannot emit light, at all.

On the other hand, in the above-mentioned past technologies, a lighting equipment for bicycle utilizing a semiconductor light emitting device such as, for example, a LED, power consumption of which being small, has been practically used, instead of the electric bulb utilizing a filament.

For example, the Japanese Unexamined Patent Publication No. 2004-331016 (reference No. 4) discloses a lighting equipment for a bicycle in which an alternate generator and at least one LED are connected to each other via a rectifying and smoothing circuit and a boosting circuit or the like so as to emit the LED.

In addition, the Japanese Unexamined Patent Publication No. 2005-72546 (reference No. 5) also discloses a lighting equipment for a bicycle in which an alternate generator and a LED are connected to each other via a rectifying and smoothing circuit and a boosting circuit or the like so as to emit the LED.

However, even in the above-mentioned lighting equipment utilizing the LED, when a moving speed of a bicycle is low, the generated output is low and further when a moving speed of a bicycle is low, a load applied to the user when the user drives the pedals of the bicycle, becomes significantly large so that another problem is arisen in that the user of the bicycle feels uncomfortable.

Accordingly, in the reference No. 4, the lighting equipment is configured so that an operated condition of the bicycle is sensed by a suitable sensor thereby the lighting equipment turning on control means is driven so that the LED is emitted.

And further, in the reference No. 5, lighting equipment for a bicycle is so configured that a circuit for detecting the generated electric power and for controlling an amount of load of a power source in accordance with the sensed result, is additionally provided.

However, both lighting equipments have a highly complicated and complexity circuit thereby this circuit causing to raise up a production cost thereof.

### SUMMARY OF THE INVENTION

The present invention is invented in order to overcome these past problems of the lighting equipment and an object of the present invention is to provide a lighting equipment having a light emitting means comprising at least one LED and which can be continuously turned on at uniformed high level of brightness with small driving energy and which having a simple and small sized configuration as well as having light weight and cheaper cost.

Especially, the present invention is to provide a new sophisticated lighting equipment used for a bicycle which can make it possible to continuously emit light uniformly for a long time with high brightness even when a moving speed of the bicycle is a low speed corresponding to a walking speed of a normal human being.

In addition to the above-mentioned, another object of the present invention is to provide a lighting equipment which does not have any consumption good such as, for example, a battery or the like and which can make it possible to turn on at high brightness continuously even in day time which can contribute to a so called “Day Time Running Light” campaign under which a head light lamp is tuned on even in a day time so as to previously prevent an traffic accident from being occurred, such campaign being nation-widely promulgated, recently.

Therefore, in order to attain the above-mentioned object of the present invention, the present invention basically adopts the following technical features.

Note that a first aspect of the present invention is a lighting equipment which comprises a small sized direct current motor having an ability for generating electricity and a light emitting means comprising at least one LED, wherein a rotor axis of the small sized direct current motor is rotated at high rotational speed to generate the electricity whereby the light generating means emits light continuously and uniformly in high brightness condition.

More specifically, in the present invention, the small sized direct current motor is preferably a small sized direct current motor, for example, having a volume of less than 8000 mm³ and a weight of less than 100 g.

Further, a second aspect of the present invention is a lighting equipment which comprises a small sized direct current motor having an ability for generating electricity and a light emitting means comprising at least one LED, wherein the lighting equipment is further provided with a rotation transmitting means which rotates a rotor axis of the small sized direct current motor at high rotational speed and further wherein the rotation transmitting means being provided with a kinetic energy transmitting function to transmit the same to said rotor axis with a rotational speed which is lower than a rotational speed of the rotor axis to thereby generate the electricity from the small sized direct current motor with the rotor axis so that said light emitting means emits light continuously and uniformly in high brightness condition.

More specifically, in the present invention, the rotation transmitting means as used in the lighting equipment of the present invention is a means having a function, for example, to rotate the rotor axis at a high speed utilizing a difference between a diameter of a wheel of a vehicle and a diameter of the rotor axis, and more specifically, in a bicycle for an example, the function has a possibility to rotate the rotor axis of the direct current motor at around 165 turns for one rotation of a wheel of the bicycle.

In accordance with the present invention, the lighting equipment of the present invention can emit light with sufficient amount of brightness within a wide range of moving speed of a bicycle, such as, for example, around 2 to 16 km/h and accordingly, this lighting equipment is very convenient to use and especially, sufficient amount of brightness can be obtained only with the small sized direct current motor at a moving speed of the bicycle at around 2 to 4 km/h which corresponding to a walking speed for a normal human being.

Note that, in the present invention, sufficient amount of brightness which is equal to or more than a level of the brightness used in so called “Day time running light” and obtained by automobile head lamp utilizing LEDs, can be obtained and therefore such “Day Time Running Light” campaign under which the head light lamp of a vehicle is turned on when the vehicle moves in a day time, can be realized on a bicycle accompanied by an angle adjustment mechanism.

Further note that, in these years, a traffic accident in which an auto bicycle is entangled in and crushed by a large sized automobile on its left hand side portion of a large sized heavy duty vehicles, has been effectively prevented from being occurred by continuously turning on a head light lamp of the auto bicycle even in the day time.

Therefore, with utilizing the present invention, such “Day Time Running Light” campaign can be introduced into the bicycles so that traffic security and safety can be improved as in the automobiles and the auto bicycles leading to make a great social contribution on the traffic safeties.

Regarding the consumption of electric power, the consumption of electric power of the conventional electric bulb show 3.0 to 6.0 W.

On the other hand, in the present invention, a semiconductor light emitting device, for example, a LED or the like which is used in the light emitting means, normally shows a rating electric voltage of 3.1 V and rating electric current of 80 mA and thus even when 2 LEDs are used in the light emitting means, the consumption of electric power is only about 0.5 W which being too small comparing with that of the conventional electric bulb, note that, it shows only 8 to 17% of the consumption of electric power of the conventional electric bulb.

With utilizing this saving of the electric power, it can be possible to make an electric power generating ability of the generator small as well as to make the size of the generator small.

In this case, there is additional advantage in which an user's load applied to the user when he drives the pedals of the bicycle can be reduced.

On the other hand, since in the present invention, no consumption good, such as a battery is used, the lighting equipment of the present invention can be used semi-permanently and thus the present invention can provide an eco-friendly device.

In addition, although in the present invention, a small sized direct current motor is used as a generator, a lots of such kind small sized direct current motors are used in mass in the electric appliances such as CD or DVD recording and reproducing devices as well as in the moving toys and further even when the makers for producing such motors are different from each other, a size or electrical characteristics of such motors are commonly designed from each other and thus so called “de facto standard” is established among these motors.

Accordingly, in the present invention, the lighting equipment can be produced with cheaper cost comparing with a producing cost of the hub dynamo reducing the lighting equipment of the present invention to be economical good.

### BRIEF DESCRIPTION OF DRAWINGS

FIG. 1 shows a schematic view illustrating a configuration of one embodiment of the lighting equipment based on the present invention.

FIG. 2 shows a graph explaining a relationship between a rotation number of a small sized direct current motor used in the present invention and an output of direct current.

FIG. 3 shows a graph explaining a relationship between a moving speed of a bicycle and a rotation number of a small sized direct current motor used in the present invention.

FIG. 4 shows a graph explaining a relationship between a moving speed of a bicycle and an output of direct current in the lighting equipment of the present invention.

FIG. 5 shows a graph explaining a relationship between a moving speed of a bicycle and brightness in the lighting equipment of the present invention.

FIG. 6 is a circuit diagram showing a configuration. of a controlling circuit provided inside a light emitting means used in the present invention.

FIG. 7 is a schematic view showing an embodiment of a lighting equipment of the present invention in which the lighting equipment is attached on a bicycle.

FIG. 8 is a drawing in which a small sized direct current motor used in the present invention and a conventional alternate current motor are compared with each other.

FIG. 9 is a drawing illustrating a difference in rotation number of the small sized direct current motor used in the present invention and that of a conventional alternate current motor.

### DESCRIPTION OF THE PREFERRED EMBODIMENTS

The preferred embodiments of the present invention will be explained with reference to the attached drawings, hereunder.

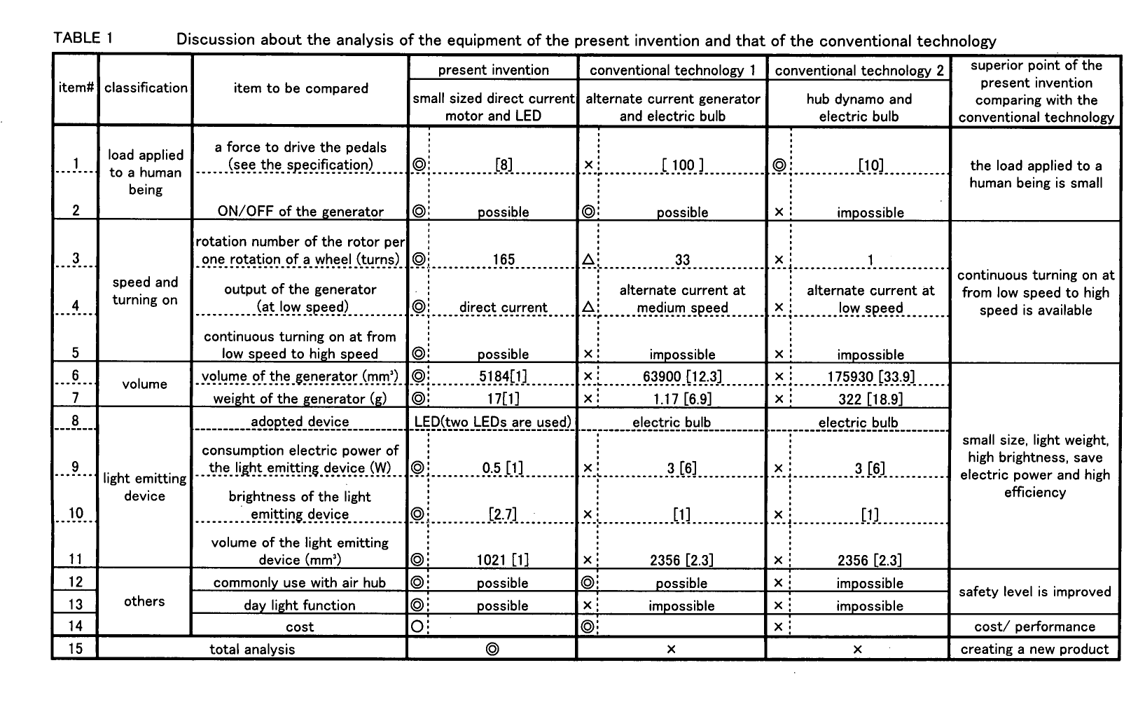

Note that, FIG. 1 shows a configuration of one specific embodiment of lighting equipment 10 related to the first aspect of the present invention.

In FIG. 1, a lighting equipment 10 is shown and which comprises a small sized direct current motor 1 having an ability for generating electricity and a light emitting means 5 comprising at least one LED 15, wherein a rotor axis 2 of said small sized direct current motor 1 is rotated at high rotational speed to generate the electricity, whereby said light generating means 5 emits light continuously and uniformly at high brightness condition.

And further in FIG. 1, the driving terminal 4, 4′ of the small sized direct current motor 1 and the input terminals 7, 7′ provided on a substrate plate 6 of the light emitting means 5 with the LED 15 are connected to each other directly via a pair of conduction wires 8, 8′, without interposing any one of a rectifier circuit and an electric energy storage circuit such as, for example, a capacitor, therebetween.

As a small sized direct current motor 1 used in the present invention, any type of currently commercialized small sized direct current motor, which can generate electric power as a generator by rotating its rotor, can be used.

But, especially a small sized direct current motor which having a small size and light weight as well as having high amount of electric power output with a configuration which can bear with high speed rotating condition, can be preferably used in the present invention.

On the other hand, a small sized direct current motor 1 used in the present invention, preferably has a diameter of the rotor axis being less than 5 mm and an external diameter of the rotor being less than 20 mm.

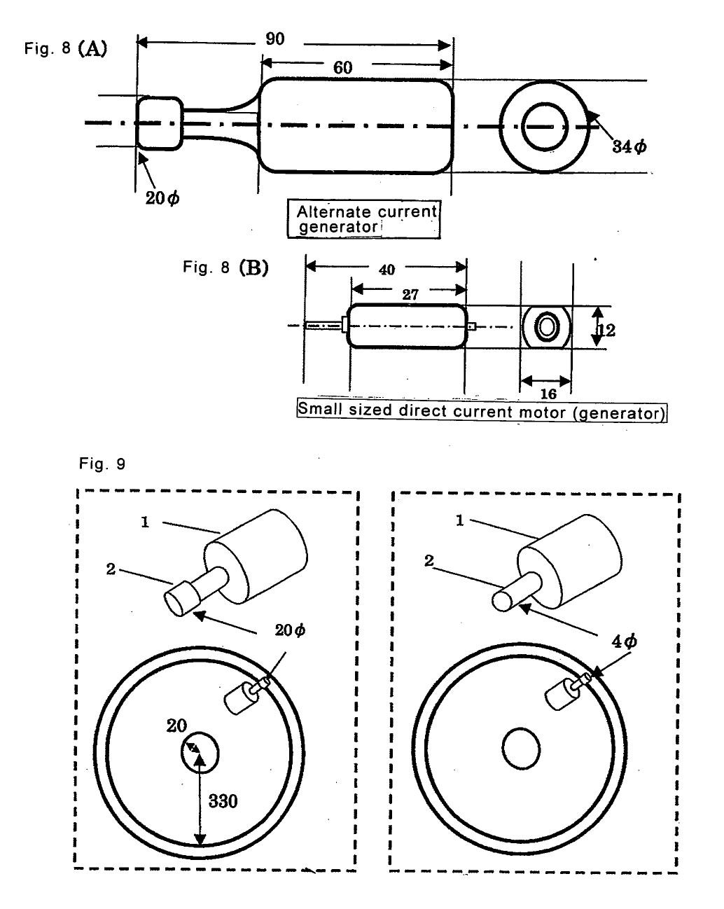

For example, as shown in FIG. 8(B), as one specific embodiment of the small sized direct current motor as used in the present invention, it is preferred that the motor has a volume of 5184 mm³ with specifications of a length, a width and a height thereof being 16 mm, 27 mm and 12 mm, respectively and a total weight thereof being 17 g, and a diameter of the rotor axis 2 being less than 5 mm and the external diameter of the rotor 3 being less than 10 mm and further wherein having a possible rotation number of the rotor being around 1000 to 10000 rpm, more preferably 1000 to 6000 rpm as well as having an output electric power being about 1 W.

Comparing the above mentioned characteristics with those of the current alternate current generators used for a bicycle, as shown in FIG. 8(A), one typical alternate current generator has a volume of 63900 mm³ with a specification of 34φ×30 mm and having a weight of 117 g.

Therefore, the conventional alternate current generator is larger than the small sized direct current motor as used in the lighting equipment of the present with 12.3 times in volume and 6.9 times in weight.

Note that these kind of differences affect greatly to cost for energy in operating the illumination.

In the present invention, the small sized direct current motor having an electric power generating ability which can be used in the present invention, as shown in FIG. 8(B), the size thereof is greatly minimized comparing with that of the conventional alternate current generator used for a bicycle and for example, a small sized direct current motor having a code name of FF-050SB produced by Mabuchi Motor company in Japan or a small sized direct current motor having a code name of FF-050S produced by Nichibo Motor company in Japan both of which being such de facto standard, are preferably used in the present invention.

Next, in the present invention, the rotation transmitting means 42 for rotating the rotor axis 2 of the small sized direct current motor 1 at high rotational speed, is provided in this lighting equipment and it is given a function to transmit kinetic energy to the rotor axis 2 with a rotational speed lower than that of the rotor axis 2.

By doing this, the generation of the electric power can be performed by such small sized direct current motor 1 having the rotor axis 2 so that the light emitting means 5 of the present invention can emit light continuously with uniformed high level of brightness.

The configuration of the rotation transmitting means 42 is not restricted to a specific embodiment but any kind of configuration which having such function to have the rotor axis 2 rotated at high rotational speed, can be used in the present invention.

As shown in FIG. 9, in one embodiment thereof, an outer peripheral edge portion of a rotating member having a larger diameter comparing with that of the rotor axis 2 is used as the rotation transmitting means 42.

More specifically, the rotation transmitting means 42 has a function, for example, which has a possibility to rotate the rotor axis 2 of the direct current motor 1 with around 165 turns for one rotation of a wheel of the bicycle, utilizing a difference in between a size of diameter of a wheel and a size of the diameter of the rotor axis 2.

On the other hand, the number of the LEDs 15 as used in the lighting equipment 5 of the present invention may be one or more, for example, the number of which may preferably be 2 to 8.

Each of the LEDs 15 can be arranged in a serial form or in a parallel form and in a case may be, they are arranged in a mixed serial and parallel form.

Further, in the present invention, when a plurality of the LEDs 15 are used, it is possible to selectively select one or more respective desired LEDs to be emitted utilizing a specific selecting means.

Note that, as the LEDs 15 which can be used in the present invention, it is prefer that the LED 15 has low electric power consumption and having a possibility to emit light with high brightness.

In a specific embodiment, as a LED 15 which can be used in the present invention, for example, a LED 15 having a diameter of 10 mm φ and a length of 13 mm as well as a volume of 1021 mm³ with electric power consumption of 248 mmW, can be preferably used. In comparing this with those of the conventional electric bulb utilizing a filament, since the conventional one has a light emitting device with a specification of a diameter being 10 mm φ, a length being 30 mm as well as a volume being 2356 mm³ with electric power consumption being 3 to 6 W, the LED 15 as used in the present invention is minimized in a volume by 2.3 times of the volume of the conventional one, so that the present invention has good advantage in performing minimization.

On the other hand, in the present invention, in a case when two of the above-mentioned LEDs 15 are simultaneously used, and when they are driven with a voltage of 3.1 V and with a current of 160 mmA, brightness was measured.

Simultaneously with this, brightness of an electric bulb driven at voltage of 3 V and with current of 1000 mA was also measured.

In comparing the present invention with the conventional one, assuming that the value of the brightness of the electric bulb is 1, the brightness of the LED 15 of the present invention is 2.7 times brighter than that of the electric bulb and regarding electric power consumption for both cases, assuming that the amount of the electric power consumption for the LED 15 of the present invention is 1, the electric bulb consumes the electric power 6 times larger than that of the present invention.

As explained above, the lighting equipment 10 of the present invention, as shown in FIG. 1, the small sized direct current motor 1 and the light emitting means 5 including the LED 15 are directly connected with each other only via two conduction wires 8, 8′.

On the other hand, in the conventional lighting equipment, it is an inevitable configuration thereof that a rectifier circuit and/or a smoothing circuit should be provided between a generator and a lighting equipment and further it is also an inevitable configuration thereof that a separate device such as a battery and/or a capacitor which can make possible to emit an electric bulb when an output voltage of a generator is low level, should also be provided between a generator and a lighting equipment.

However, in the present invention, no such electric device is needed to be interposed between the motor and the light emitting means.

In a specific embodiment of the present invention, it is possible for the lighting equipment to emit light to obtain illumination with keeping sufficient amount of brightness on moving a bicycle in night time at least with a moving speed of a bicycle at around 2 km/h.

Note that, in the small sized direct current motor 1 of the present invention, since it has a small size in volume with having a light weight and can be rotated at high rotating speed, it is also possible for the rotor to reach at predetermined high rotating speed momentary and thus direct current electric power necessary to emit light from the LED 15 can also be obtained momentary.

And further, since the LED 15 has a configuration of low electric power consumption and also has a possibility for emitting light with high level of brightness, the lighting equipment of the present invention does not require to have a rectifier circuit and it can also keep a certain amount of output voltage sufficient to emit light from the LED 15 except for a very short period just after the rotor 2 of the small sized direct current motor 1 is started to rotate.

Therefore, it is not required in the lighting equipment of the present invention to store a predetermined necessary electric power in a capacitor or a battery as well as for lighting equipment to be provided with the capacitor or the battery therein.

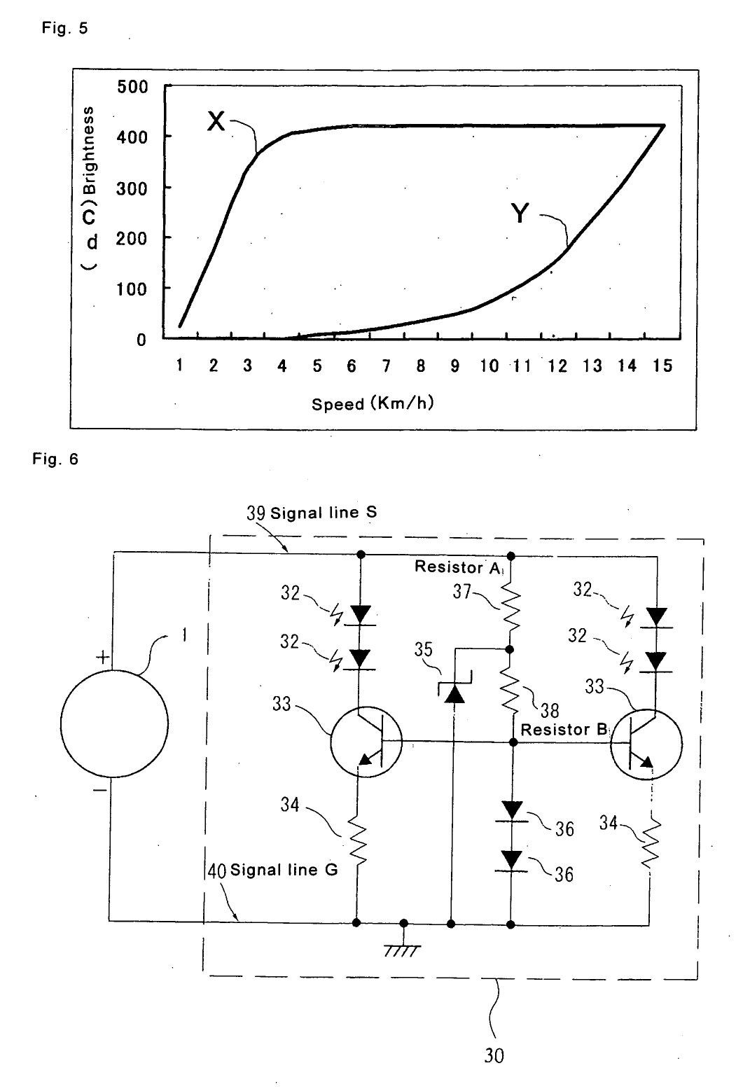

Note that, the light emitting means of the present invention, as shown by a graph X illustrated in FIG. 5, can keep its brightness at a certain amount of level independent of the rotational number of the small sized direct current motor 1 except for a very short period just after the small sized direct current motor 1 is started to rotate so as to make it possible for the light emitting means to emit the light continuously.

In other word, in the present invention, the LED 15 is configured so that when the small sized direct current motor 1 is driven to be rotated, and just simultaneously with it, the LED 15 used in the lighting equipment 5 is turned on.

Note that, a graph Y as illustrated in FIG. 5 shows a relationship between a variation in brightness of a lamp in a conventional lighting equipment utilizing a electric bulb with a filament and a moving speed of a bicycle.

And as shown by this graph Y, the brightness thereof is apparently changed with depending upon the speed of the bicycle.

As mentioned above, an establishment of a condition for the brightness when the LED 15 used in the present invention emits light can be controlled, for example, by matching an internal impedance of the small sized direct current motor (generating device) 1 with a load impedance of the LED 15 used in the lighting equipment 5.

By doing this, an upper limit of an amount of electric current flowed through the LED 15 can be controlled.

The matching operation can be carried out by specifying designing factors, for example, a winding ratio of the small sized motor or the like.

Alternately, it can also be realized by using a driving current controlling circuit 30 for controlling a driving current of the LED and which comprises only an electronics circuit provided with resistors, diodes, transistors or the like and without using a rectifier circuit and by implanting the same into a part of the substrate plate 6 of the light emitting means 5, as shown in FIG. 6.

Note that, in order to control the light emitting condition of the light emitting means 5 more precisely and more effectively, the driving current controlling circuit 30 for the LED of the present invention is preferably provided on the substrate plate of the light emitting means 5.

And as mentioned above, this configuration is one variation of embodiments of the present invention within a scope of the basic configuration of the present invention in that none of a rectifier circuit, a smoothing circuit as well as a battery and a capacitor is provided between the generator and the light emitting means.

Note that, FIG. 6 shows one embodiment of a configuration of the LED driving current controlling circuit 30 as used in the present invention and a specific construction and an operation thereof will be explained precisely hereunder.

The lighting equipment 10 of the present invention, has a configuration in that the output voltage output from the small sized direct current motor 1 is connected to the LED 32.

In this embodiment, two LEDs 32, one transistor 33 and one resistor 34 are connected with each other in a serial form and in this embodiment, two pairs of these series arrangements are provided.

Note that in this embodiment, four LEDs 32 can be turned on simultaneously.

As explained above, in the lighting equipment 10 of the present invention, the small sized direct current motor 1 is preferably configured to output a predetermined electric power.

And the lighting equipment of the present invention is further provided with a controlling means which can control within a predetermined period, an upper limit of an amount of electric current flowed through the LED provided in the light emitting means caused by an output power generated from the direct current motor or the small sized direct current generating device each having an ability for generating electricity, to restrict the rotated at high rotational speed to restrict small sized direct current motor is a small sized direct current generating device which can be configured to output a predetermined electric power.

Further, in the present invention, the controlling means is configured so that the upper limit of an amount of electric current flowed through the LED provided in the light emitting means caused by an output power generated from the direct current motor or the small sized direct current generating device can control the upper limit of an amount of electric current flowed through the LED provided in the light emitting means, by matching an internal impedance of the small sized direct current motor with a load impedance of the LED provided in the light emitting means.

And the controlling means used in the lighting equipment of the present invention, is provided with a driving current controlling means which controls to drive the LED, wherein the driving current controlling means comprises only electronic circuit devices without including any number of rectifier circuits.

In another embodiment of the present invention, the driving current controlling means is further provided with a LED selecting means which arbitrarily selects at least one predetermined LED to be emitted among a plurality of LEDs.

In FIG. 6, 1 denotes a generator utilizing a small sized direct current motor which is attached to a bicycle and this small sized direct current motor 1 uses a rotation of a wheel of the bicycle as a driving source.

The small sized direct current motor 1 has a configuration in that a rotor axis of the small sized direct current motor 1 is attached to a tire portion or a rim portion of the bicycle so that a magnet of the rotor is rotated to generate an electromotive force.

As a method for generating electricity in a bicycle, as mentioned above, a method by using so called hub-dynamo system is available, in that magnets is provided at a hub portion of a wheel of a bicycle to generate the electromotive force.

This kind of electric energy generating method has a technical conception similar to that in which a rotating kinetic energy of a wheel of a bicycle is converted into an electric energy but its output is relatively small and the level of output voltage is completely depending upon the number of rotation of the wheel, and thus when a moving speed of the bicycle is low, an output voltage generally having a ripple like configuration with a long repetition frequency is obtained.

Accordingly, a light emission thereof becomes intermittently or a large amount of variation in brightness will be occurred.

Further, since the hub-dynamo is always provided on a hub portion of a wheel of a bicycle, an ON/OFF operation of the light emitting means is not available and thus another problem is arisen in which a force required to operate the pedals of a bicycle is enlarged comparing with a force required to operate the same when no generation function is needed in a day time.

On the other hand, the transistor 33 has a function for controlling a driving current used in the light emitting diode 32.

And a base voltage is supplied to a base of the transistor 33 through a bias circuit comprising a resister A 37, a resister B 38 and a diode 36.

In addition, a voltage of a signal pass S 39, which is an output voltage output from the generator 1 and a certain amount of voltage which is adjusted from the output voltage with a potential division ratio as set in the bias circuit is applied to a base of the transistor 33.

As the output voltage of the generator increases, the vase voltage is also increased proportionally and accordingly the transistor 33 controls the current flowed through the light emitting diode 32 in proportion with the base voltage change.

Further, when the output voltage output form the generator is increased, the zener diode 35 provided in the bias circuit becomes ON condition that means that a voltage of the zener diode 35 is fixed at a constant voltage level and accordingly a difference in voltage formed between this fixed voltage and the output voltage output from the generator is applied at both terminals of the resistor A 37.

On the other hand, the base voltage of the transistor 33 shows a voltage level which can make the transistor 33 in a saturated condition that means an ON condition and thus a saturated electric current of the transistor 33 that is a constant current flows through the light emitting diode 32.

Under this situation, when the voltage exceeds a certain level determined by the zener diode 35, the light emitting diode 32 can stably and continuously emit light even when some variation would be occurred in the generator.

When these operations is reviewed from a total system point of view, a speed range in which the LED emits light in proportion with an output voltage of the small sized direct current motor 1 that means a speed of a bicycle and another speed range in which the LED emits light with keeping it at a constant brightness level when the speed of the bicycle exceeds a certain amount of level thereof are realized.

A graph X as shown in FIG. 5 shows a relationship between such varied condition in the brightness of the LED and the speed of the bicycle.

The small sized direct current motor 1 is rotated by the rotor axis 2 which is contacted or connected to a suitable rotational driving member so that the small sized direct current motor 1 is used as a small sized generator.

In the present invention, the rotor axis 2 of the small sized direct current motor 1 is preferably rotated at least at 1000 rpm.

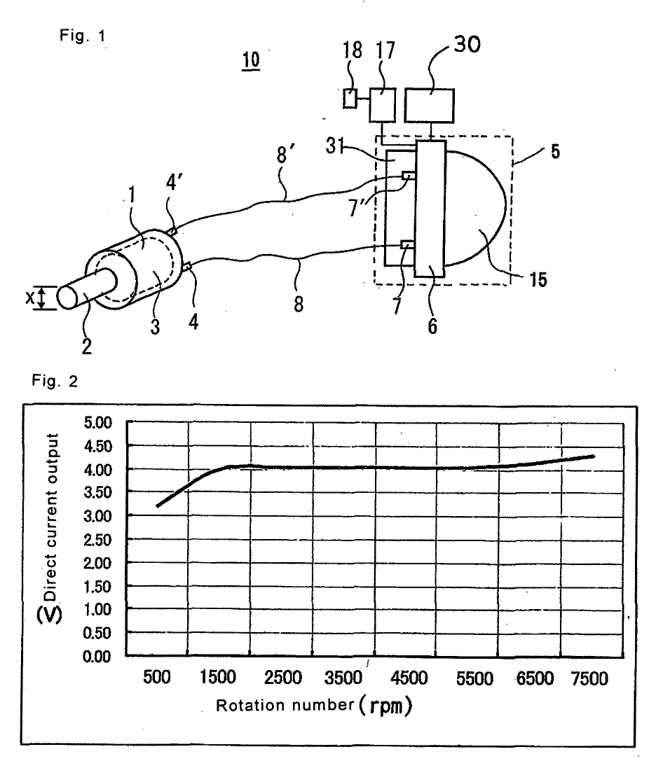

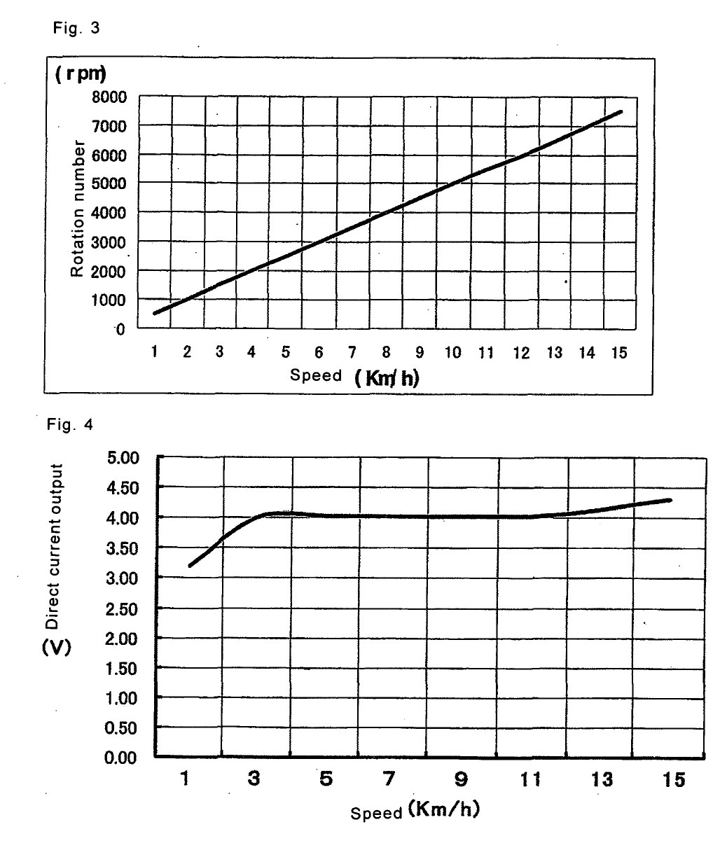

A relationship between the number of rotation of the rotor axis 2 of the small sized direct current motor 1 in the present invention and an output voltage or a relationship between the rotation number and the speed of a bicycle are shown in FIGS. 2 and 3, respectively.

Further in the present invention, based upon a relationship between an amount of the output voltage output from the small sized direct current motor 1 and an amount of electric power consumption of the respective LEDs 15, a number of LEDs which can be used in the present invention can be determined.

Alternately, as mentioned above, by utilizing a selection switching circuit, it can be possible that a certain number of LEDs 15 which should emit light is arbitrarily selected among a plurality of the LEDs 15.

Accordingly, the lighting equipment 10 of the present invention can be applied to any kind of fields in which a suitable external driving means which can rotate the rotor axis 2 of the small sized direct current motor 1 is available.

For example, any kind of wheels of moving vehicles or moving carriers having one or more wheels can be used as a driving means in the present invention.

Further, when a fly wheel or the like which can be rotated by manual operation is utilized, the present invention can be used for a lighting equipment of toys and a flashlight as well as when a light emitting means provided inside toys, furniture, electric appliances, life articles or the like can be emitted by utilizing a some suitable movable part provided therein and which can be moved by hand of an user thereof, they are also embodiments of the present invention.

In one of embodiments of the present invention, the small sized direct current motor 1 can be used for a lighting equipment of a bicycle by attaching the rotor axis 2 thereof to a rim portion of a wheel of a bicycle and by causing the rotor axis 2 to be rotated at high rotation speed due to a moving operation of a surface of the rim portion.

Note that advantages obtained when the lighting equipment 10 of the present invention is used for lighting equipment of a bicycle will be explained hereunder with comparison with conventional lighting equipment of a bicycle.

First, in the conventional lighting equipment of a bicycle driven by batteries which has been generally used in the past, there is absolutely no load for generating electric power to be applied to an user when the user drives the bicycle but an exhaustion of the battery is so remarkable that frequent exchange of the battery is necessary and further a life time of an electric bulb is short.

Therefore, ultimately, the problem in that a cost of usage thereof should be increased, is significant leading a use rate thereof to be reduced.

On the other hand, in the method for obtaining electric power, an alternate current generator that is popular as a lighting equipment for a bicycle in the past and which is shown in the reference No. 1, is attached to a tire portion of a bicycle so as to rotate the generator.

However, in this embodiment, a weight of the alternate current generator per se is large and a load applied to an user of the bicycle for generating electric power is significantly huge, as well as when a moving speed of the bicycle is low, since no electric power is generated or an output electric power is very low, a light emitting means 5 cannot emit light even when it is provided with LEDs.

Accordingly, there is a big problem in that an user will be suffered from many dangers when the user drives a bicycle on a sloped road at night or the user walks with pushing the bicycle.

Further, in the method in which the alternate current generator is driven by attaching it to a tire portion, since a stable output electric power cannot be obtained for a bicycle to move with a speed at between low moving speed and high moving speed, a light emission condition of the light emitting means 5 is unstable and thus it is inconvenient for an user of a bicycle in practical point of view. Note that, in the above-mentioned method, since the connection between the alternate current generator and the tire portion can be arbitrarily attained by selection of an user, there is an advantage in which the user's load for operating the pedals of the bicycle can be reduced by putting the contacting condition between the alternate current generator and the tire portion into a non-contacting condition with each other in day time.

On the other hand, in a case in which a lighting equipment for a bicycle utilizing a hub dynamo as shown in the reference No. 3 is used, electromotive force is generated by providing magnets on a hub portion of a wheel of a bicycle and thus a load for generating electric power applied to an user is relatively small comparing with that of the above-mentioned method in which the alternate current generator is attached to a tire portion, but the load is significantly larger than that of the present invention.

Further, in this case, when a moving speed of the bicycle is low, since no electric power is generated or an output electric power is very low, a light emitting means cannot emit light even when it is provided with LEDs.

Accordingly, there is big problem in that an user will be suffered from many dangers when the user drives a bicycle on a sloped road in night time or the user walks with pushing the bicycle.

In addition to above-mentioned, even in this method utilizing the hub dynamo, since a stable output electric power cannot be obtained during the time when a bicycle moves with a speed at between a low moving speed and a high moving speed, a light emission condition is unstable and thus it is inconvenient for an user of a bicycle in practical point of view.

Note that, in the method utilizing the hub dynamo, since it is impossible to disconnect the generator from the rotation of a wheel, the hub dynamo necessarily performs to generate electric power even in day time and accordingly another problem is arisen in that an user must always bear an additional load for generating electric power in performing to drive pedals of the bicycle.

On the other hand, it is already known that there is a system called as “Auto light” in which day time condition is automatically sensed thereby the lighting equipment is automatically turned off.

And even when this “Auto light” system would be introduced into the above-mentioned method, since the electric power generating function thereof cannot be stopped, the load applied to the user for operating the pedal cannot be reduced, even after the lamp is turned off.

In comparing with these analysis, in the present invention, although the connection formed between the small sized direct current motor 1 and the tire portion 21′ or the rim portion 21 of a wheel of a bicycle can be arbitrarily set by the user and thus in day time, user can disconnect the connection formed between them but basically in the present invention, the small sized direct current motor 1 is used and thus even when the small sized direct current motor 1 is connected to either one of the tire portion 21′ or the rim portion 21 of a wheel of a bicycle, the above mentioned load applied to an user of a bicycle for performing to drive pedals of the bicycle to generate electric power is not substantially existed and thus even if the contact formed therebetween is always existed, the user does not feel inconvenience thereabout.

Here, the inventor of the present invention has estimated about how extent a level of the load applied to an user in performing to drive pedals of a bicycle is differed from each other in a case when a conventional method is used and in a case when the present invention is used, by carrying out comparative tests about a driving force necessary to rotate a wheel of a bicycle.

Note that, the force for a human being to drive the pedals of a bicycle is a source of energy for rotating a wheel so that a bicycle can move the surface of the earth but in the present invention, an additional load for driving the small sized direct current motor (a generator) is added to the above-mentioned normal load.

Therefore, this additional load was measured by the experiments.

In this experiments, the method for measuring the load is such that a force which is required when a wheel thereof just has been started to rotate from a stationary condition of the wheel, (this force corresponds to a maximum static friction force) was measured both in a case when the generator was contacted to the wheel and in a case when the generator was not contacted to the wheel, respectively.

The results thus obtained in the following three cases, are as follows;
Case 1: a load for generation caused by the present invention;
   0.23(N)8%
Case 2: a load for generation caused by a hub dynamo;
   0.29(N)10%
Case 3: a load for generation caused by a conventional alternating current generator;
   2.96(N)100%
   wherein N denotes Newton and the figures represented in percentage (%) denotes a proportional value when the value of Newton in the case 3 was assumed to be 100.

From these results of the experiments, the necessary force to generate electric power in the present invention is only 8% of that when a conventional alternating current generator is used and the load of the present invention is some what smaller comparing with the case 2 when the hub dynamo was used and the necessary force to generate electric power is 10% of that when a conventional alternating current generator is used.

Further, in the present invention, since it is possible for LEDs to emit light continuously with a certain level of constant high brightness at any moving speed of a bicycle among a range from a low speed to a high speed thereof, sufficient amount of illumination can be obtained even when an user walks along a road with pushing a bicycle in night time thereby safety in using a bicycle can be further improved.

A lighting equipment used for a bicycle as one of a specific embodiments for its applications in the present invention will be explained hereunder.

As shown in FIG. 1, in the lighting equipment 10 of the present invention, it is a basic technical conception in that the light emitting means is continuously emitted with constant high level of brightness.

However, in a case may be, since there would preferably exist a case in that the light emitting means should emit light intermittently, it is preferable that a suitable intermittent light emission processing circuit 17 is provide inside the substrate plate 6 of the light emitting means 5 as well as a switching circuit 18 which can be operated by an user manually so that the user can control the intermittent light emission processing circuit 17 is provided on the substrate plate 6.

Note that, in the above-mentioned embodiment of the present invention, the intermittent light emission processing circuit 17 which can serve as a driving circuit for setting the turning on condition of each one of the LEDs 15 at either one of the continuous turning on condition and the intermittent turning on condition, and the switching means 18 which can select either one of the above-mentioned two condition are provided.

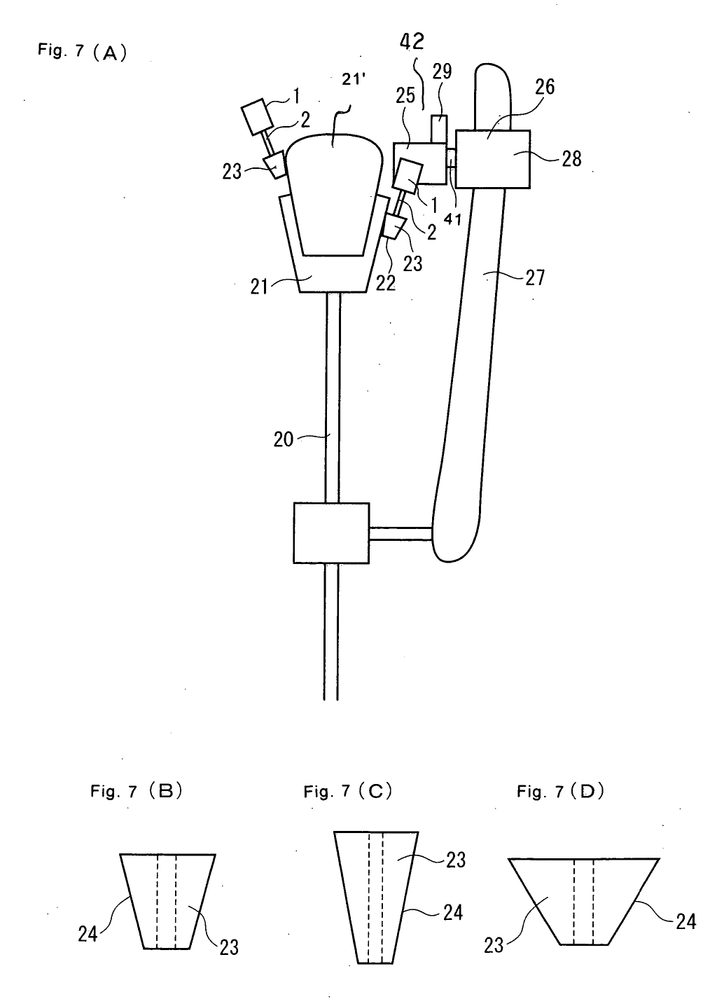

Further, as a specific application of the present invention, as shown in FIG. 7, the lighting equipment as mentioned above, is used for a bicycle, in that a part of the rotor axis 2 of the small sized direct current motor 1 is attached to at least a part of a rim portion 21 which is provided in a wheel 20 of a bicycle and the rotor axis 2 of the small sized direct current motor 1 is rotated with high rotational speed in accordance with a movement of the rim portion 21.

In addition, a portion 22 of the rotor axis 2 of the small sized direct current motor 1 as used in the present invention and which is about to be connected to a rim portion 21 of a bicycle is provided with a rotation supporting member 23 which is made of a material having a relatively large friction characteristic.

It is preferable that the rotation supporting member 23 is made of material or materials such as gum, poly-urethane resin, poly vinyl chloride resin or the like, each having big frictional coefficient against metal.

Further, it is preferable that the rotation-supporting member 23 may be detachably attached to a part of a tip portion of the rotor axis 2 of the small sized direct current motor 1.

Note that an outer peripheral surface of the rotation supporting member 23 may preferably be provided with suitable grooves or suitable concave and convex portions as well as suitable projecting ridge like portions, in order to improve frictional effect on a contacting surface formed between the rotation supporting member 23 and the rim portion 21.

Note that in the present invention, by attaching the rotor axis 2 of the small sized direct current motor 1 to the rim portion 21 of a wheel of a bicycle and which having a smooth metallic surface, it becomes possible that the connecting condition formed between the rotor axis 2 of the small sized direct current motor 1 and the rim portion 21 which is a source of driving the motor 1, becomes stable it can be maintained fixedly and uniformly.

And further, since the outer surface of the rim portion forms a smooth and uniform flat surface, the connecting condition formed between the rotation supporting member 23 provided on a tip portion of the rotor axis 2 of the small sized direct current motor 1 and the surface of the rim portion 21 can be maintained in a stable condition thereby the rotor axis 2 is rotated with uniform high rotational speed reducing a value of an output voltage output from the motor 1 being kept in a stable condition.

Accordingly, in a separate embodiment of the present invention, it is preferable that the small sized direct current motor 1 may be attached to a rim portion 21 of a wheel of a bicycle, a metallic surface of which shows smooth surface.

By adopting the above-mentioned configuration in the present invention, it can be realized that the rotor axis 2 of the small sized direct current motor 1 can be rotated stably even which the motor 1 rotates with very high rotational speed therefore, noise generation of the present invention can also be remarkably reduced.

Note that in the present invention, it is understood that when the rotor axis 2 of the small sized direct current motor 1 is attached to the rim portion, a lot of advantages or effects can be obtained comparing with a case in which a rotor axis 2 of the small sized direct current motor 1 is attached to a tire portion 21′ of a wheel of a bicycle.

Further, more preferably, it is possible that a surface of the rim portion 21 to which a tip portion of the rotor axis 2 of the small sized direct current motor 1 is attached, is provided a coarse surface by applying a suitable rough surface processing so as to form suitable grooves or suitable concave and convex portions as well as suitable projecting ridge like portions thereon, can be used.

On the other hand, as shown in FIG. 7, an external surface of the rotation supporting member 23 is preferably provided with a tapered portion 24 with forming a predetermined angle formed between the tapered direction and a center axis of the rotor axis 2.

And further, a relationship between a surface position of the rim portion 21 and a position at which the small sized direct current motor 1 is arranged is widely changeable depending upon kinds, types, designs, model number of a bicycle or the like, and accordingly, an arranged relationship at a contacting portion formed between the rotor axis 2 of the small sized direct current motor 1 and the surface of the rim portion 21 is not fixedly established.

Therefore, a tapered angle formed between the rotor axis 2 of the small sized direct current motor 1 and the surface of the rim portion 21 is not fixedly set.

From these point of views, it is preferable that a plurality of the rotation supporting members 23 each having a respective tapered angle being different from each other, are previously prepared and when the lighting equipment 10 of the present invention is actually attached to a suitable part of a bicycle, one of the rotation supporting members 23 having a suitable tapered angle is selected to use for attaching the lighting equipment 10 to a bicycle.

Further in the present invention, it is another preferable embodiment in that when the lighting equipment 10 is put into a market, a plurality of the rotation supporting members 23 each having the respective tapered angle from each other, are collectively assembled and are sold with the lighting equipment 10 as a kit.

Note that, as shown in FIG. 7, in this embodiment, a mall sized direct current motor supporting means 28 which can have the rotor axis 2 of the small sized direct current motor 1 stably attached to a part of the rim portion 21 of the wheel portion 20 of a bicycle is used.

For example, as shown in FIG. 7, it is preferable embodiment of the present invention in which the small sized direct current motor supporting means 28 is provided with a small sized direct current motor supporting member 25 and a holding means 26 to fixedly secure the small sized direct current motor supporting member 25 on a suitable portion of a part of a main body portion of a bicycle such as a fork portion 27.

Further, in the present invention, it is also preferable that the small sized direct current motor supporting means 28 can be attached to any one of a front wheel fork, a rear wheel fork and other portion of a bicycle.

It is a separate preferable embodiment of the present invention in that the lighting equipment 10 is so configured that the small sized direct current motor 1 is secured on the small sized direct current motor supporting member 25 with swing free or pivot free condition and further it is also preferable that the lighting equipment 10 in this embodiment, is provided with the above-mentioned small sized direct current motor supporting means 28 which comprises the small sized direct current motor supporting member 25 and the above-mentioned holding means 26, and the small sized direct current motor supporting means 28 further has a specific connecting means 41, such an universal joint or the like whereby the small sized direct current motor supporting member 25 and the above-mentioned holding means 26 can be mutually supported and secured on the small sized direct current motor supporting means 28 even when both of the supporting member 25 and the holding means 26 are mutually arranged to each other with any kind of indefinite arranging configuration.

Further, it is also preferable that the small sized direct current motor supporting means 28 of the present invention is designed so that it can be detachably attached to any one of a front wheel fork portion of a bicycle, a rear wheel fork portion of a bicycle or other suitable portion of a bicycle.

By introducing this mechanism into the present invention, the present invention makes it possible for an user to arbitrarily exchange the currently using lighting equipment 10 with a separate one which having at least one of a size, a design and functions thereof being different from that of a currently using lighting equipment 10 and to use the same by attaching it to a bicycle.

In the same manner, in the present invention, the small sized direct current motor 1 attached to the small sized direct current motor supporting means 28, is preferably configured so that it is detachably attached to the small sized direct current motor supporting means 28.

By doing this, when the small sized direct current motor 1 is broken or malfunctioned or when it is required to change its design or to exchange the old one with a new improved one, although an exchanging operation is required, in the present invention, this operation can be simplified.

On the other hand, in the present invention, it is also a preferable embodiment in that the small sized direct current motor supporting member 25 may be provided with a connected condition changing mechanism 29 which can arbitrarily select either one of a connecting condition in that the rotor axis 2 of the small sized direct current motor 1 is attached to the rim portion 21 of the wheel of a bicycle and a disconnecting condition in that the rotor axis 2 of the small sized direct current motor 1 is removed from the rim portion 21.

Note that in this embodiment, it is preferable that a connected condition changing mechanism 29 is provided and which can put the rotor axis 2 of the small sized direct current motor 1 into either one of a connecting position at which the rotor axis 2 being connected to a rim portion 21 or a tire portion 21′ or a disconnecting position at which the rotor axis 2 being disconnected therefrom. And further, in this embodiment, the connected condition changing mechanism 29 may have a configuration in that the above-mentioned ON/OFF control of the connected condition changing mechanism 29 can be performed by manual operation by an user or by electric signal automatically.

As mentioned above, in the lighting equipment of a bicycle of the present invention, the light emitting means 5 can continuously emit light with keeping the light in a certain amount of constant level with high brightness, for example, at least 400 cd or the like, independent of the moving speed of a bicycle except for under a condition in that the bicycle moves at low speed less than 2 Km/h.

In addition, in the present invention, the lighting equipment of the present invention is so configured that the LEDs 5 of the light emitting means 5 are turned on simultaneously with a time when the bicycle just starts to move.

In the present invention, it is another preferable embodiment of the present invention that optical axises of the LEDs 15 can be freely switched into any one of upper direction, lower direction, left direction and right direction.

Accordingly, when this kind of switching function is added to the characteristics of the present invention comprising the save electric power function and the continuous turning on function, an extremely effective day light system can be realized.

Note that, specifically, in order to fixedly secure the light emitting means 5 mainly comprising the LEDs 15 on a handle portion or a fork portion of a bicycle, the holding means 26 or a handle attaching means (not shown) is provided with a suitable optical axis changing mechanism and accordingly, the optical axis can be freely changed in response to a necessity.

On the other hand, in a further different embodiment of the present invention, the small sized direct current motor 1 as mentioned above, the light emitting means 5 comprising at least one LED 15 and the small sized direct current motor supporting means 28 can be collected into one package and they can be sold in a market as a kit.

Further in a separate embodiment of the present invention, the small sized direct current motor 1 as mentioned above, the light emitting means 5 comprising at least one LED 15, the small sized direct current motor supporting means 28 and a plurality of the rotation supporting member 23 each of which having the respective tapered portion the angle of which being different from each other, can be collected into one package and they can also be sold in a market as a kit.

Hereunder, differences in functions and effects existing between the lighting equipment of the present invention and the conventional lighting equipment will be explained.

Note that the merits and demerits of both equipments as well as superior characteristics of the present invention over the conventional one are shown in the table 1 below, in that three kinds of lighting equipments such as a lighting equipment of the present invention, a lighting equipment having a combination of a conventional alternate current generator and an electric bulb with a filament (denoted as a conventional device 1) and a lighting equipment having a combination of a conventional hub dynamo and an electric bulb with a filament (denoted as a conventional device 2).

In reviewing the title of “a load applied to an user when the user operates to drive the pedals” as shown in the item 1, in accordance with the above-mentioned measuring results, assuming that the value of the load in the conventional device 1 would be set as 100, the value of the load in the conventional device 2 shows 10 while the value of the load of the present invention shows 8.

Therefore, it can be understood that the load of the present invention can be reduced comparing with that of the conventional device 1.

Next, in reviewing the “ON/OFF function” of the generation mechanism as shown in the item 2, the ON/OFF mechanism can be arbitrarily effected in the present invention and the conventional device 1, but it is difficult in the conventional device 2.

In the conventional device 2, since electric power is generated even when the lighting equipment is not required to be turned on and accordingly, it means that meaningless load is applied to the user.

On the other hand, a relationship between the moving speed of a bicycle and the turning on of the lighting equipment as shown in the item 3 in the table 1 is analyzed.

As described above, in the conventional device 2, one rotation of the wheel of the bicycle corresponds to one rotation of the hub of the bicycle while in the conventional device 1, when the wheel of the bicycle is rotated one rotation, a roller axis of the alternate current generator having a diameter of 20 mm, can be rotated by 33 turns.

As the same reason, when a small sized direct current motor is used in the present invention, since the diameter of the rotor axis is so small comparing with the conventional device 1, the rotation number of the rotor axis is remarkably increased and it becomes 165 turns.

This number of turns of the rotor axis is also remarkably enlarged comparing with that in the conventional device 2.

Accordingly, in the present invention, it is suggested that the small sized direct current motor can be rotated uniformly with high rotational speed .

Further, regarding the output of the generator as shown in the item 4 of the table 1, note that in the conventional device 1 and 2, an alternate current is generated and especially in the conventional device 2, the rotation number of the rotor is very small when the rotation speed is low and thus a variation in output voltage is large reducing an uniform and high brightness light emission impossible.

On the other hand, in reviewing a possibility of lighting equipment turning on continuously in response to variation in a moving speed of a bicycle among a range from low speed to high speed, as shown in the item 5 in the table 1, in the conventional device 1 and the conventional device 2, from the reason as mentioned above, since only an output voltage completely proportional to the moving speed of the bicycle is obtained, it is impossible to realize the continuous turning on of the lighting equipment with high brightness and independent of the moving speed of the bicycle even a capacitor is commonly used therewith.

Further, in the items 6, 7 and 11 in the table 1, the value of volumes and a value of weights of the generators and light emitting devices each comprising each one of the three lighting equipments, respectively are compared with each other.

Note that especially the volume and the weight of the generator of the present invention is greatly minimized comparing with those of the conventional devices 1 and 2 and thus this face shows one of very important factors of the present invention. In reviewing an electric power consumption in the light emitting device of each one of the lighting equipments as shown in the item 9 in the table 1, the electric power consumption of the present invention shows only 0.5 W even when two LEDs are used, while both of the conventional devices 1 and 2 show that the electric power consumption thereof is 3 W and thus it can be understood that the present invention can reduce the electric power consumption by one sixth of that of the conventional devices 1 and 2.

Further, regarding brightness of the light emitting device as shown in the item 10 in the table 1, when the brightness is measured with utilizing the same level of input electric power, the present invention shows that the brightness thereof is 2.7 times brighter than those of the conventional devices 1 and 2.

Regarding to make commonly use of an air hub as shown in the item 12 in the table 1, it is impossible in the conventional device 2 but it is possible in the present invention and the conventional device 1.

Accordingly, in the present invention, it is possible to introduce a new configuration in which an air pressure inside a tire can be automatically adjusted.

The item 13 in the table 1 shows a new corrective function in which the factors to be analyzed as indicated in the items 1 to 11 in the table 1 are corrected.

Accordingly, for an user driving a bicycle, the force for driving the pedals is small but continuous light emission with high level of brightness can be realized at any level of a moving speed of a bicycle in a range from a low moving speed to a high moving speed thereof.

In addition thereto, the present invention shows a small lighting equipment having light weight with good save consumption of electric power, and thus the lighting equipment of the present invention is suitable device for using the day light system in day time.

Regarding the cost as shown in the item 14 in the table 1, in the present invention, save materials can be realized by minimizing the size of the lighting equipment and a direct current motor which is made by a mass production and becomes a de facto standard in this industrial field are used.

Further in the present invention, both of a battery which being a consumed good and an electric bulb with a filament, are not used.

Accordingly, in the present invention, the lighting equipment which can be produced with the most cheapest production cost, can be obtained in comparing with the costs of the conventional devices 1 and 2.

In addition to thereabout, the present invention can greatly contribute to so called save resources and keep environment campaign.

Regarding the total analysis as shown in the item 15 in the table 1, it can be understood that the present invention is remarkable and sophisticated equipment comparing with the conventional devices 1 and 2 in the following points; such as,

(1) Regarding the main characteristic factor of the lighting equipment, the lighting equipment of the present invention shows a stable light emission with highly brightness at a moving speed within a range of from a low speed to a high speed.

(2) Regarding the save resources and save energy, the lighting equipment of the present invention can contribute to save electric power and save materials due to a size thereof being minimized as well as can contribute to suppress consumption.

(3) Regarding convenience in using the equipment, in the lighting equipment of the present invention, a force to drive the pedals is small and the electric power generating function can be easily controlled either one of in ON condition and OFF condition as well as it can easily introduce an air hub system.

(4) Regarding economy about this equipment, the lighting equipment of the present invention shows a low production cost and remarkable save electric power ability.]

From these characteristics, it is understood that the present invention has created a new lighting equipment provided with new function by collectively assembling the conventional technologies.

As mentioned above, in a separate embodiment of the present invention, the lighting equipment is further provided with a switching means 18 which can selectively select a turning-on condition of the LED provided inside the light emitting means, either one of in a continuous turning-on condition or in an intermitted turning-on condition.

It is apparent from the above-mentioned explanation, that another embodiment of the present invention is lighting equipment especially used for a bicycle.

And further, in the lighting equipment used for a bicycle of the present invention, the light emitting means emits light continuously with keeping a level of brightness exceeding a predetermined level of brightness independent of a speed of a bicycle except for a predetermined speed condition of the bicycle.

This means that in the lighting equipment used for a bicycle of the present invention, the LED of the light emitting means can be turned on simultaneously with the bicycle starts to move.

In addition to the above-mentioned, the lighting equipment used for a bicycle of the present invention is further provided with a system in which an optical axis of the LED can be freely switched into any one of upper direction, lower direction, left direction and right direction.

Accordingly, the present invention is suitable for using lighting equipment used for a bicycle.

What is claim is:

1. A lighting equipment which comprises a small sized direct current motor having an ability for generating electricity and a light emitting means comprising at least one LED(Light Emitting Diode), wherein a rotor axis of said small sized direct current motor is rotated at high rotational speed to generate the electricity whereby said light generating means emits light continuously and uniformly in high brightness condition.

2. A lighting equipment which comprises a small sized direct current motor having an ability for generating electricity and a light emitting means comprising at least one LED(Light Emitting Diode), wherein said lighting equipment further provided with a rotation transmitting means which rotates a rotor axis of said small sized direct current motor at high rotational speed and further wherein said rotation transmitting means being provided with a kinetic energy transmitting function to transmit the same to said rotor axis with a rotational speed which is lower than a rotational speed of said rotor axis to thereby generate the electricity from said small sized direct current motor with said rotor axis so that said light emitting means emits light continuously and uniformly in high brightness condition.

3. A lighting equipment according to claim 1 or 2, wherein said small sized direct current motor is a small sized direct current generating device which can be configured to output a predetermined electric power.

4. A lighting equipment according to claim 3, wherein said lighting equipment is further provided with a controlling means which can control within a predetermined period, an upper limit of an amount of electric current flowed through said LED provided in said light emitting means caused by an output power generated from said direct current motor or said small sized direct current generating device each having an ability for generating electricity.

5. A lighting equipment according to claim 4, wherein said controlling means is provided with a means in that said upper limit of an amount of electric current flowed to said LED provided in said light emitting means from said small sized direct current motor or said small sized direct current generating device can be controlled, by matching an internal impedance of said small sized direct current motor or said small sized direct current generating device with a load impedance of said LED provided in said light emitting means.

6. A lighting equipment according to claim 4, wherein said controlling means is provided with a driving current controlling means which controls the drive current for said LED, and which comprises only electronic circuit devices without including any of rectifier circuit.

7. A lighting equipment according to claim 6, wherein said driving current controlling means is further provided with a LED selecting means which arbitrarily selects at least one predetermined LED to be emitted among a plurality of LEDs.

8. A lighting equipment according to any one of claims 1, 2 and 4 to 7, wherein said lighting equipment is further provided with a switching means which can selectively select a turning-on condition of said LED provided inside said light emitting means from either one of a continuous turning-on condition or an intermitted turning-on condition.

9. A lighting equipment used for a bicycle which comprising said lighting equipment as defined by any one of claims 1, 2 and 4 to 8.

10. A lighting equipment used for a bicycle according to claim 9, wherein said light emitting means emits light continuously with keeping a level of brightness exceeding a predetermined level of brightness independent of a speed of a bicycle except for a predetermined speed condition of the bicycle.

11. A lighting equipment used for a bicycle according to claim 10, wherein said LED of said light emitting means can be turned oh simultaneously with said bicycle starts to move and further an optical axis of said LED can be freely switched into any one of direction selected from a group comprising an upper direction, a lower direction, a left direction and a right direction.
